(19) United States
(12) Patent Application Publication
(10) Pub. No.: US 2026/0297327 A1
(43) Pub. Date: Oct. 1, 2026

(54) RESIN COMPOSITION AND ARTICLE MADE THEREFROM

(71) Applicant: Elite Material Co., Ltd., Taoyuan City (TW)

(72) Inventor: Chen-Yu HSIEH, Taoyuan City (TW)

(21) Appl. No.: 19/195,995

(22) Filed: May 1, 2025

(30) Foreign Application Priority Data
Mar. 26, 2025 (TW) 114111439

(51) Int. Cl. C08L 79/08; C08G 73/12; C08J 5/24; C08K 3/28; C08K 5/53; C08K 5/55

(52) U.S. Cl. CPC C08L 79/085; C08G 73/12; C08J 5/244; C08K 3/28; C08K 5/53; C08K 5/55; C08J 2379/08; C08L 2201/02; C08L 2203/16; C08L 2203/20; C08L 2205/03

(57) ABSTRACT

A resin composition includes a copolymer and a phosphorus-containing flame retardant, the copolymer being prepared from a mixture subjected to a copolymerization reaction, wherein the mixture includes a maleimide resin and a diamine compound, the maleimide resin includes an aromatic maleimide resin and an aliphatic maleimide resin, and the phosphorus-containing flame retardant has a structure represented by Formula (1). The resin composition may be used to make various articles, including a prepreg, a resin film, a laminate or a printed circuit board, and one or more of the properties can be improved, including glass transition temperature, Z-axis coefficient of thermal expansion, dielectric constant, dissipation factor, copper foil peeling strength and flame retardancy.

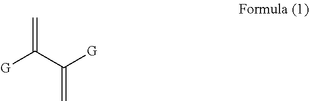

### CROSS-REFERENCE TO RELATED APPLICATION

This application claims the priority benefits of Taiwan Patent Application No. 114111439, filed on Mar. 26, 2025. The entirety of the above-mentioned patent application is hereby incorporated by reference herein and made a part of this specification.

### BACKGROUND

### 1. Field of the Disclosure

The present disclosure relates to a resin composition and more particularly to a resin composition useful for preparing a prepreg, a resin film, a laminate or a printed circuit board.

### 2. Description of Related Art

In recent years, due to the development of electronic signal transmission toward 5G and the trend of miniaturization and high performance of electronic equipment, communication devices and personal computers, circuit boards for these applications were also developed toward multi-layer configuration, high density trace interconnection, and high speed signal transmission, thereby presenting higher challenges to the overall performance of circuit laminates such as copper-clad laminates.

Accordingly, there is a need to provide a novel material meeting the property requirements of circuit boards used nowadays.

### SUMMARY

To overcome the problems of prior arts, particularly one or more property demands facing conventional materials, it is a primary object of the present disclosure to provide a resin composition and an article made from the resin composition, which may achieve improvements in at least one or more desirable properties including glass transition temperature, Z-axis coefficient of thermal expansion, dielectric constant, dissipation factor, copper foil peeling strength and flame retardancy.

To achieve the above-mentioned objects, the present disclosure provides a resin composition, comprising:
a copolymer prepared from a mixture subjected to a copolymerization reaction, wherein the mixture comprises a maleimide resin and a diamine compound, and the maleimide resin comprises an aromatic maleimide resin and an aliphatic maleimide resin; and
a phosphorus-containing flame retardant having a structure represented by Formula (1):

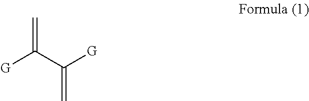

wherein G each independently represent a group of Formula (2) or a group of Formula (3):

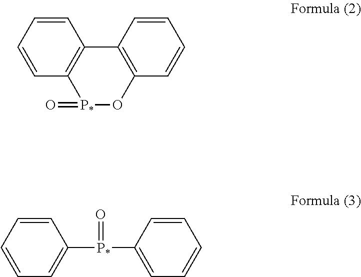

wherein symbol * represents a bonding position to carbon atom.

For example, in one embodiment, the resin composition of the present disclosure comprises 100 parts by weight of the copolymer and 20 parts by weight to 60 parts by weight of the phosphorus-containing flame retardant.

For example, in one embodiment, the mixture comprises the aromatic maleimide resin, the aliphatic maleimide resin and the diamine compound in a molar ratio of between 2:0.5:0.1 and 5:2:1.

For example, in one embodiment, the phosphorus-containing flame retardant has a structure of Formula (1-1):

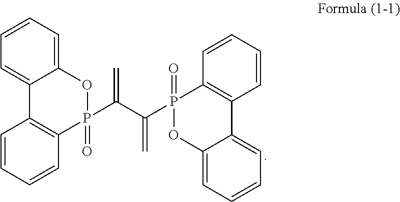 [SMILES: C=C(C(=C)P1(=O)Oc2ccccc2-c2ccccc21)P1(=O)Oc2ccccc2-c2ccccc21]

For example, in one embodiment, the phosphorus-containing flame retardant has a structure of Formula (1-2):

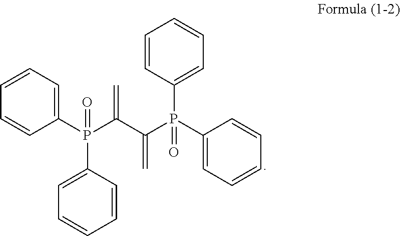 [SMILES: C=C(C(=C)P(=O)(c1ccccc1)c1ccccc1)P(=O)(c1ccccc1)c1ccccc1]

For example, in one embodiment, the aromatic maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide containing isopropylidene and m-phenylene structure or a combination thereof.

For example, in one embodiment, the aliphatic maleimide resin comprises 1,6-bismaleimide-(2,2,4-trimethyl)hexane, maleimide containing a C₁₀ to C₅₀ aliphatic long chain structure or a combination thereof.

For example, in one embodiment, the diamine compound comprises 4,4′-(1,4-phenylenediisopropylidene)bisaniline, a diamine compound containing a siloxane structure or a combination thereof.

For example, in one embodiment, the resin composition further comprises an additive which comprises a vinyl group-containing polyphenylene ether resin, a polyimide resin, a benzocyclobutene, a diallyl ether compound or a combination thereof.

For example, in one embodiment, the resin composition further comprises inorganic filler, curing accelerator, polymerization inhibitor, solvent, silane coupling agent, coloring agent, toughening agent or a combination thereof.

Moreover, the present disclosure also provides an article made from the resin composition described above, which comprises a prepreg, a resin film, a laminate or a printed circuit board.

For example, in one embodiment, articles made from the resin composition disclosed herein have one, more or all of the following properties:
a glass transition temperature as measured by reference to IPC-TM-650 2.4.24.5 of greater than or equal to 211° C.;
a Z-axis coefficient of thermal expansion as measured by reference to IPC-TM-650 2.4.24.5 of less than or equal to 47 ppm/° C.;
a dielectric constant as measured by reference to JIS C2565 at 10 GHz of less than or equal to 3.49;
a dissipation factor as measured by reference to JIS C2565 at 10 GHz of less than or equal to 0.0046;
a copper foil peeling strength as measured by reference to IPC-TM-650 2.4.8 of greater than or equal to 4.01 lb/in; and
a flame retardancy of V-0 rating as measured by reference to UL94.

### DESCRIPTION OF THE EMBODIMENTS

To enable those skilled in the art to further appreciate the features and effects of the present disclosure, words and terms contained in the specification and appended claims are described and defined. Unless otherwise defined, all technical and scientific terms used herein have the same meaning as commonly understood by those of ordinary skill in the art to which this disclosure pertains. In the case of conflict, the present document and definitions contained herein will control.

While some theories or mechanisms may be proposed herein, the present disclosure is not bound by any theories or mechanisms described regardless of whether they are right or wrong, as long as the embodiments can be implemented according to the present disclosure.

As used herein, “a,” “an” or any similar expression is employed to describe components and features of the present disclosure. This is done merely for convenience and to give a general sense of the scope of the present disclosure. Accordingly, this description should be read to include one or at least one and the singular also includes the plural unless it is obvious to mean otherwise.

As used herein, “or a combination thereof” means “or any combination thereof”, and “any” means “any one”, vice versa.

As used herein, the term “comprises,” “comprising,” “includes,” “including,” “encompass,” “encompassing,” “has,” “having” or any other variant thereof is construed as an open-ended transitional phrase intended to cover a non-exclusive inclusion. For example, a composition or article of manufacture that comprises a list of elements is not necessarily limited to only those elements but may include other elements not expressly listed but inherent to such composition or article of manufacture. Further, unless expressly stated to the contrary, the term “or” refers to an inclusive or and not to an exclusive or. For example, a condition “A or B” is satisfied by any one of the following: A is true (or present) and B is false (or not present), A is false (or not present) and B is true (or present), and both A and B are true (or present). In addition, whenever open-ended transitional phrases are used, such as “comprises,” “comprising,” “includes,” “including,” “encompass,” “encompassing,” “has,” “having” or any other variant thereof, it is understood that transitional phrases such as “consisting essentially of” and “consisting of” are also disclosed and included.

As used herein, the term “and” or any other variant thereof is used to connect parallel sentence components, and there is no distinction between the front and rear components. The meaning of the parallel sentence components does not change in the grammatical sense after the position is exchanged.

In this disclosure, features or conditions presented as a numerical range or a percentage range are merely for convenience and brevity. Therefore, a numerical range or a percentage range should be interpreted as encompassing and specifically disclosing all possible subranges and individual numerals or values therein, particularly all integers therein. For example, a range of “1 to 8” should be understood as explicitly disclosing all subranges such as 1 to 7, 2 to 8, 2 to 6, 3 to 6, 4 to 8, 3 to 8 and so on, particularly all subranges defined by integers, as well as disclosing all individual values such as 1, 2, 3, 4, 5, 6, 7 and 8. Similarly, a range of “between 1 and 8” should be understood as explicitly disclosing all ranges such as 1 to 8, 1 to 7, 2 to 8, 2 to 6, 3 to 6, 4 to 8, 3 to 8 and so on and encompassing the end points of the ranges. Unless otherwise defined, the aforesaid interpretation rule should be applied throughout the present disclosure regardless broadness of the scope.

Whenever amount, concentration or other numeral or parameter is expressed as a range, a preferred range or a series of upper and lower limits, it is understood that all ranges defined by any pair of the upper limit or preferred value and the lower limit or preferred value are specifically disclosed, regardless whether these ranges are explicitly described or not. In addition, unless otherwise defined, whenever a range is mentioned, the range should be interpreted as inclusive of the endpoints and every integers and fractions in the range.

Given the intended purposes and advantages of this disclosure are achieved, numerals or figures have the precision of their significant digits. For example, 40.0 should be understood as covering a range of 39.95 to 40.04.

As used herein, a Markush group or a list of items is used to describe examples or embodiments of the present disclosure. A skilled artisan will appreciate that all subgroups of members or items and individual members or items of the Markush group or list can also be used to describe the present disclosure. For example, when X is described as being “selected from a group consisting of X₁, X₂ and X₃,” it is intended to disclose the situations of X is X₁ and X is X₁ and/or X₂ and/or X₃. In addition, when a Markush group or a list of items is used to describe examples or embodiments of the present disclosure, a skilled artisan will understand that any subgroup or any combination of the members or items in the Markush group or list may also be used to describe the present disclosure. Therefore, for example, when X is described as being “selected from a group consisting of X₁, X₂ and X₃” and Y is described as being “selected from a group consisting of Y₁, Y₂ and Y₃,” the disclosure includes any combination of X is X₁ and/or X₂ and/or X₃ and Y is Y₁ and/or Y₂ and/or Y₃.

Unless otherwise specified, according to the present disclosure, a compound refers to a chemical substance formed by two or more elements bonded with chemical bonds and may comprise a small molecule compound and a polymer compound, but not limited thereto. Any compound disclosed herein is interpreted to not only include a single chemical substance but also include a class of chemical substances having the same kind of components or having the same property. In addition, as used herein, a mixture refers to a combination of two or more compounds.

Unless otherwise specified, according to the present disclosure, a polymer refers to the product formed by monomer(s) via polymerization and usually comprises multiple aggregates of polymers respectively formed by multiple repeated simple structure units by covalent bonds; the monomer refers to the compound forming the polymer. A polymer may comprise a homopolymer, a copolymer, a prepolymer, etc., but not limited thereto. A homopolymer refers to the polymer formed by the polymerization of one monomer. A copolymer refers to the polymer formed by the polymerization of two or more different monomers. For example, copolymers may comprise: random copolymers, such as a structure of -AABABBBAAABBA-; alternating copolymers, such as a structure of -ABABABAB-; graft copolymers, such as a structure of -AA(A-BBBB)AA(A-BBBB)AAA-; and block copolymers, such as a structure of -AAAAA-BBBBBB-AAAAA-. The term “polymer” includes but is not limited to an oligomer. An oligomer refers to a polymer with 2-20, typically 2-5, repeating units.

Unless otherwise specified, the term “resin” of the present disclosure is a widely used common name of a synthetic polymer and is construed as comprising monomer and its combination, polymer and its combination or a combination of monomer and its polymer, but not limited thereto.

Unless otherwise specified, according to the present disclosure, a modification comprises a product derived from a resin with its reactive functional group modified, a product derived from a prepolymerization reaction of a resin and other resins, a product derived from a crosslinking reaction of a resin and other resins, a product derived from homopolymerizing a resin, a product derived from copolymerizing a resin and other resins, etc.

As used herein, “vinyl group-containing” refers to the presence of an ethylenic carbon-carbon double bond (C═C) or a functional group derived therefrom in a compound. Therefore, examples of “vinyl” or “vinyl group-containing” may include, but not limited to, a structure containing a vinyl group, a styryl group, an allyl group, a vinylbenzyl group, a methacrylate group or the like. Unless otherwise specified, the position of the aforesaid functional group is not particularly limited and may be located at the terminal of a long-chain structure. Therefore, for example, a vinyl group-containing resin represents a resin containing a vinyl group, a styryl group, an allyl group, a vinylbenzyl group, a methacrylate group or the like, but not limited thereto.

As used herein, part(s) by weight represents weight part(s) in any weight unit, such as but not limited to gram, kilogram, pound and so on. For example, 100 parts by weight of the copolymer may represent 100 grams of the copolymer, 100 kilograms of the copolymer or 100 pounds of the copolymer, but not limited thereto. As used herein, if the amount of components is presented in a proportional relationship, the actual amount can be any amount that conforms to the proportional relationship.

The following embodiments and examples are illustrative in nature and are not intended to limit the present disclosure and its application. In addition, the present disclosure is not bound by any theory described in the background and summary above or the following embodiments or examples.

As described above, a main object of the present disclosure is to provide a resin composition, which comprises:
a copolymer prepared from a mixture subjected to a copolymerization reaction, wherein the mixture comprises a maleimide resin and a diamine compound, and the maleimide resin comprises an aromatic maleimide resin and an aliphatic maleimide resin; and
a phosphorus-containing flame retardant having a structure represented by Formula (1):

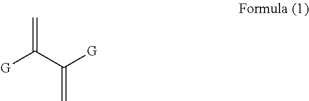

wherein G each independently represent a group of Formula (2) or a group of Formula (3):

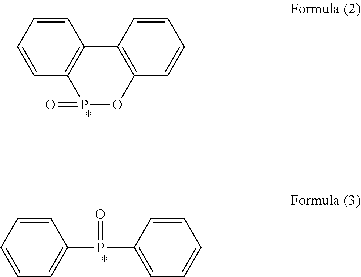

wherein symbol * represents a bonding position to carbon atom.

For example, in one embodiment, the amount of the copolymer and the phosphorus-containing flame retardant is not particularly limited. For example, the resin composition of the present disclosure may comprise 100 parts by weight of the copolymer and 20 parts by weight to 60 parts by weight of the phosphorus-containing flame retardant. For example, relative to 100 parts by weight of the copolymer, the resin composition of the present disclosure may comprise 20 parts by weight, 25 parts by weight, 30 parts by weight, 35 parts by weight, 40 parts by weight, 45 parts by weight, 50 parts by weight, 55 parts by weight or 60 parts by weight of the phosphorus-containing flame retardant, but not limited thereto.

For example, in one embodiment, the conditions of the copolymerization reaction are not particularly limited. For example, the mixture including the maleimide resin (the maleimide resin includes an aromatic maleimide resin and an aliphatic maleimide resin) and the diamine compound may be subjected to the copolymerization reaction under high temperature conditions (such as but not limited to between 100° C. and 150° C.). For example, in one embodiment, the mixture may further comprise other components. For example, the mixture may comprise a catalyst (such as a catalyst for synthesis), and the copolymerization reaction may be performed in the presence of a catalyst. The type of the catalyst is not particularly limited and may comprise, for example, ethylenediamine. For example, the mixture may comprise a solvent, and the copolymerization reaction may be performed in the solvent. The type of the solvent is not particularly limited and may comprise propylene glycol methyl ether acetate, dimethylacetamide or a combination thereof.

As described above, the reactant (i.e., a monomer) participating in the copolymerization reaction may comprise but is not limited to an aromatic maleimide resin, an aliphatic maleimide resin and a diamine compound, and the amount of the three reactants is not particularly limited. For example, in one embodiment, the molar ratio of an aromatic maleimide resin, an aliphatic maleimide resin and a diamine compound is between 2:0.5:0.1 and 5:2:1. For example, in one embodiment, the molar ratio of an aromatic maleimide resin, an aliphatic maleimide resin and a diamine compound is 3:1:1, but not limited thereto.

In addition, the time of the copolymerization reaction is not particularly limited, such as between 1 hour and 10 hours.

For example, in one embodiment, the weight average molecular weight of the copolymer may be adjusted by changing the conditions of the copolymerization reaction. For example, in one embodiment, the copolymer has a weight average molecular weight of between 1500 and 5000.

For example, in one embodiment, the aromatic maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide containing isopropylidene and m-phenylene structure or a combination thereof. For example, in one embodiment, the aromatic maleimide resin comprises but is not limited to bisphenol A diphenyl ether bismaleimide resin (such as BMI-80, available from K.I Chemical Industry Co., Ltd.), 3,3′-dimethyl-5,5′-diethyl-4,4′-diphenylmethane bismaleimide resin (such as BMI-70, available from K.I Chemical Industry Co., Ltd.), maleimide containing isopropylidene and m-phenylene structure (such as MIR-5000, available from Nippon Kayaku), or a combination thereof.

For example, in one embodiment, the aliphatic maleimide resin comprises 1,6-bismaleimide-(2,2,4-trimethyl)hexane, maleimide containing a C₁₀ to C₅₀ aliphatic long chain structure or a combination thereof. For example, in one embodiment, the aliphatic maleimide resin comprises but is not limited to 1,6-bismaleimide-(2,2,4-trimethyl)hexane (such as BMI-TMH, available from Sichuan EM Technology Co., Ltd.).

For example, in one embodiment, the diamine compound comprises 4,4′-(1,4-phenylenediisopropylidene)bisaniline, a diamine compound containing a siloxane structure or a combination thereof. For example, in one embodiment, the diamine compound comprises but is not limited to 4,4′-(1,4-phenylene diisopropylidene)bisaniline (Bisaniline P, available from Mitsui Chemicals), a diamine compound containing a siloxane structure (X-22-9409, available from Shin-Etsu Chemical Co., Ltd.), or a combination thereof.

In the resin composition of the present disclosure, the phosphorus-containing flame retardant has a structure of Formula (1):

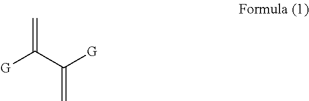

wherein G each independently represent a group of Formula (2) or a group of Formula (3):

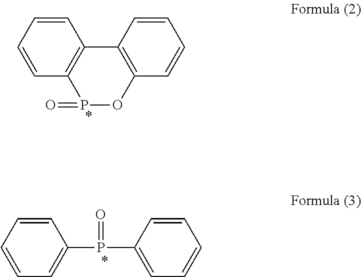

wherein symbol * represents a bonding position to carbon atom.

For example, in one embodiment, the phosphorus-containing flame retardant has a structure of Formula (1-1):

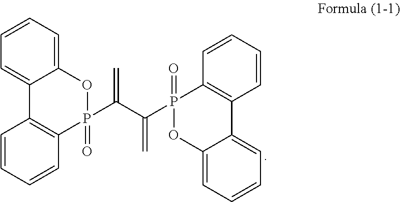 [SMILES: C=C(C(=C)P1(=O)Oc2ccccc2-c2ccccc21)P1(=O)Oc2ccccc2-c2ccccc21]

For example, in one embodiment, the phosphorus-containing flame retardant has a structure of Formula (1-2):

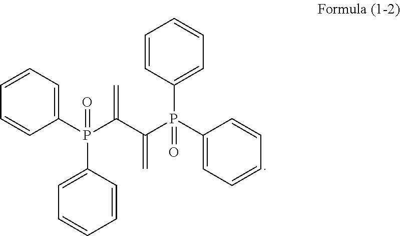 [SMILES: C=C(C(=C)P(=O)(c1ccccc1)c1ccccc1)P(=O)(c1ccccc1)c1ccccc1]

In addition to the copolymer and the phosphorus-containing flame retardant, the resin composition of the present disclosure may also optionally comprise an additive. The type of the additive is not particularly limited and may be various additives commonly used in the field. For example, in one embodiment, the additive comprises a vinyl group-containing polyphenylene ether resin, a polyimide resin, a benzocyclobutene, a diallyl ether compound or a combination thereof. Unless otherwise specified, relative to 100 parts by weight of the copolymer, the content of any aforesaid component may be 5 to 50 parts by weight, such as 5, 10, 15, 20, 25, 30, 35, 40, 45 or 50 parts by weight, but not limited thereto. For example, in one embodiment, by adding an additive to the resin composition, such as but not limited to a polyimide resin, the properties of an article of the resin composition may be further adjusted or improved, such as but not limited to copper foil peeling strength.

For example, the vinyl group-containing polyphenylene ether resin may comprise but is not limited to a polyphenylene ether resin containing a vinyl group, an allyl group, a vinylbenzyl group or a methacrylate group. For example, in one embodiment, the vinyl group-containing polyphenylene ether resin comprises a vinylbenzyl group-containing biphenyl polyphenylene ether resin, a methacrylate group-containing polyphenylene ether resin (i.e., methacryloyl group-containing polyphenylene ether resin), an allyl group-containing polyphenylene ether resin, a vinylbenzyl group-modified bisphenol A polyphenylene ether resin, a chain-extended vinyl group-containing polyphenylene ether resin or a combination thereof. For example, the vinyl group-containing polyphenylene ether resin may be a vinylbenzyl group-terminated polyphenylene ether resin with a number average molecular weight of about 1200 (such as OPE-2st 1200, available from Mitsubishi Gas Chemical Co., Inc.), a vinylbenzyl group-terminated polyphenylene ether resin with a number average molecular weight of about 2200 (such as OPE-2st 2200, available from Mitsubishi Gas Chemical Co., Inc.), a methacrylate group-containing polyphenylene ether resin with a number average molecular weight of about 1900 to 2300 (such as SA9000, available from Sabic), a vinylbenzyl group-modified bisphenol A polyphenylene ether resin with a number average molecular weight of about 2400 to 2800, a chain-extended vinyl group-containing polyphenylene ether resin with a number average molecular weight of about 2200 to 3000, or a combination thereof. The chain-extended vinyl group-containing polyphenylene ether resin may include various polyphenylene ether resins disclosed in the US Patent Application Publication No. 2016/0185904 A1, all of which are incorporated herein by reference in their entirety.

For example, in one embodiment, the polyimide resin described herein may be any polyimide resins known in the field to which this disclosure pertains, including but not limited to various commercially available polyimide resin products.

In one embodiment, for example, the resin composition of the present disclosure may further optionally comprise inorganic filler, curing accelerator, polymerization inhibitor, solvent, silane coupling agent, coloring agent, toughening agent or a combination thereof. Unless otherwise specified, relative to 100 parts by weight of the copolymer, the content of any aforesaid component may be 0.001 to 300 parts by weight, such as 0.001, 0.01, 0.1, 1, 5, 10, 20, 30, 40, 50, 60, 70, 80, 90, 100, 150, 200, 250 or 300 parts by weight, such as 30 to 150 parts by weight or 200 to 300 parts by weight.

The inorganic filler may be any one or more inorganic fillers used for preparing a prepreg, a resin film, a laminate or a printed circuit board; examples of inorganic filler include but are not limited to silica (fused, non-fused, porous or hollow type), aluminum oxide, aluminum hydroxide, magnesium oxide, magnesium hydroxide, calcium carbonate, aluminum nitride, boron nitride, sintered body formed by aluminum nitride and boron nitride, aluminum silicon carbide, silicon carbide, titanium dioxide, zinc oxide, zirconium oxide, mica, boehmite (AlOOH), calcined talc, talc, silicon nitride, calcined kaolin, hollow porous particle or a combination thereof. Moreover, the inorganic filler can be spherical, fibrous, plate-like, particulate, flake-like, whisker-like or a combination thereof in shape and can be optionally pretreated by a silane coupling agent. For example, relative to 100 parts by weight of the copolymer, the amount of inorganic filler used in the present disclosure is not particularly limited and may for example range from 10 parts by weight to 200 parts by weight or 100 to 300 parts by weight.

The curing accelerator (including curing initiator) may comprise a catalyst, such as a Lewis base or a Lewis acid. The Lewis base may comprise any one or more of imidazole, boron trifluoride-amine complex, ethyltriphenyl phosphonium chloride, 2-methylimidazole (2MI), 2-phenyl-1H-imidazole (2PZ), 2-ethyl-4-methylimidazole (2E4MI), triphenylphosphine (TPP), 4-dimethylaminopyridine (DMAP) and tetraphenylphosphonium tetraphenylborate. The Lewis acid may comprise metal salt compounds, such as those of manganese, iron, cobalt, nickel, copper and zinc, such as zinc octanoate or cobalt octanoate.

The curing accelerator may also encompass curing initiator such as a peroxide capable of producing free radicals, and examples of the curing initiator may comprise but not limited to: benzoyl peroxide, dicumyl peroxide, 2,5-dimethyl-2,5-di(t-butylperoxy)hexane, 2,5-dimethyl-2,5-di(t-butylperoxy)-3-hexyne, di-t-butyl peroxide, di(t-butylperoxyisopropyl)benzene, di(t-butylperoxy)phthalate, di(t-butylperoxy)isophthalate, t-butyl peroxybenzoate, 2,2-di(t-butylperoxy)butane, 2,2-di(t-butylperoxy)octane, 2,5-dimethyl-2,5-di(benzoyl peroxy)hexane, lauroyl peroxide, t-hexyl peroxypivalate, dibutylperoxy isopropylbenzene, bis(4-t-butylcyclohexyl) peroxydicarbonate or a combination thereof. For example, relative to 100 parts by weight of the copolymer, the content of curing accelerator used in the present disclosure ranges from 0.01 to 5 parts by weight, preferably 0.1 to 1.0 part by weight, more preferably 0.3 to 0.8 part by weight.

In one embodiment, for example, the polymerization inhibitor used herein is not particularly limited and may be any polymerization inhibitor known in the field to which this disclosure pertains, including but not limited to various commercially available polymerization inhibitor products. For example, the polymerization inhibitor may comprise, but not limited to, 1,1-diphenyl-2-picrylhydrazyl radical, methyl acrylonitrile, dithioester, nitroxide-mediated radical, triphenylmethyl radical, metal ion radical, sulfur radical, hydroquinone, 4-methoxyphenol, p-benzoquinone, phenothiazine, β-phenylnaphthylamine, 4-t-butylcatechol, methylene blue, 4,4′-butylidenebis(6-t-butyl-3-methylphenol), 2,2′-methylenebis(4-ethyl-6-t-butyl phenol) or a combination thereof. For example, the nitroxide-mediated radical may comprise, but not limited to, nitroxide radicals derived from cyclic hydroxylamines, such as 2,2,6,6-substituted piperidine 1-oxyl free radical, 2,2,5,5-substituted pyrrolidine 1-oxyl free radical or the like. Preferred substitutes include alkyl groups with 4 or fewer carbon atoms, such as methyl group or ethyl group. Examples of the compound containing a nitroxide radical include such as 2,2,6,6-tetramethylpiperidine 1-oxyl free radical, 2,2,6,6-tetraethylpiperidine 1-oxyl free radical, 2,2,6,6-tetramethyl-4-oxo-piperidine 1-oxyl free radical, 2,2,5,5-tetramethylpyrrolidine 1-oxyl free radical, 1,1,3,3-tetramethyl-2-isoindoline oxygen radical, N,N-di-tert-butylamine oxygen free radical and so on. Nitroxide radicals may also be replaced by using stable radicals such as galvinoxyl radicals. The polymerization inhibitor suitable for the resin composition of the present disclosure may include products derived from the polymerization inhibitor with its hydrogen atom or group substituted by other atom or group. Examples include products derived from a polymerization inhibitor with its hydrogen atom substituted by an amino group, a hydroxyl group, a carbonyl group or the like.

The purpose of adding solvent is to change the solid content of the resin composition and to adjust the viscosity of the resin composition. For example, the solvent may comprise, but not limited to, methanol, ethanol, ethylene glycol monomethyl ether, acetone, butanone (methyl ethyl ketone), methyl isobutyl ketone, cyclohexanone, toluene, xylene, methoxyethyl acetate, ethoxyethyl acetate, propoxyethyl acetate, ethyl acetate, dimethylformamide, dimethylacetamide, propylene glycol methyl ether, or a mixture thereof. The amount of solvent is not particularly limited and may be adjusted according to the viscosity required for the resin composition.

The silane coupling agent may include various silanes (such as but not limited to siloxane) or a combination thereof and may be further categorized according to the functional groups into amino silane, epoxide silane, vinyl silane, acrylate silane, methacrylate silane, hydroxyl silane, isocyanate silane, methacryloxy silane and acryloxy silane.

The coloring agent suitable for the present disclosure may comprise, but not limited to, dye or pigment.

The purpose of adding toughening agent is to improve the toughness of the resin composition. The toughening agent may comprise, but not limited to, rubber resin, carboxyl-terminated butadiene acrylonitrile rubber (CTBN rubber), core-shell rubber, or a combination thereof.

In addition to the aforesaid resin composition, the present disclosure also provides an article made from the resin composition, such as those suitable for use as components in various electronic products, including but not limited to a prepreg, a resin film, a laminate or a printed circuit board.

For example, the resin composition of the present disclosure can be used to make a prepreg, which comprises a reinforcement material and a layered structure disposed thereon. The layered structure is formed by heating the resin composition at a high temperature to the semi-cured state (B-stage). Suitable baking temperature for making a prepreg may be for example 80° C. to 160° C., preferably 100° C. to 140° C. For example, the reinforcement material may be any one of a fiber material, woven fabric, and non-woven fabric, and the woven fabric preferably comprises fiberglass fabrics. The type of the fiberglass fabric is not particularly limited and may be any fiberglass fabrics used for a printed circuit board, such as E-glass fabric, D-glass fabric, S-glass fabric, T-glass fabric, L-glass fabric, Q-glass fabric or QL-glass fabric (glass fabric with hybrid structure made of Q-glass and L-glass). The fiber may comprise yams and rovings, in spread form or standard form, and the shape of terminal face may be round or flat. Non-woven fabric preferably comprises liquid crystal polymer non-woven fabric, such as polyester non-woven fabric, polyurethane non-woven fabric and so on, but not limited thereto. Woven fabric may also comprise liquid crystal polymer woven fabric, such as polyester woven fabric, polyurethane woven fabric and so on, but not limited thereto. The reinforcement material may increase the mechanical strength of the prepreg. In one preferred embodiment, the reinforcement material can also be optionally pre-treated by a silane coupling agent. The prepreg may be further heated and cured to the cured state (C-stage) to form an insulation layer.

For example, the resin composition of the disclosure can be used to make a resin film, which is prepared by heating and baking to semi-cure the resin composition. The resin composition may be selectively coated on a supporting material, which includes but is not limited to a liquid crystal polymer film, a polytetrafluoroethylene film, a polyethylene terephthalate film (PET film), a polyimide film (PI film), a metal foil or a resin-coated copper (RCC), followed by heating and baking to semi-cure the resin composition to form the resin film.

For example, the resin composition of the present disclosure may be made into a laminate, which comprises at least two metal foils and at least one insulation layer disposed between the metal foils, wherein the insulation layer is made by curing the resin composition at high temperature and high pressure to the C-stage, a suitable curing temperature being for example between 180° C. and 240° C. and preferably between 200° C. and 220° C., a suitable curing time being 90 to 150 minutes and preferably 90 to 120 minutes, and a suitable lamination pressure being for example between 200 psi and 650 psi and preferably between 250 psi and 600 psi. The insulation layer may be obtained by curing the aforesaid prepreg or resin film. The metal foil may contain copper, aluminum, nickel, platinum, silver, gold or alloy thereof, such as a copper foil. In a preferred embodiment, the laminate is a copper-clad laminate.

In one embodiment, the laminate may be further processed by trace formation processes to obtain a circuit board, such as a printed circuit board.

For example, in one embodiment, an article made from the resin composition from each embodiment contains a reinforcement material or a supporting material and a semi-cured or cured product obtained by heating and chemically crosslinking the resin composition.

In one or more embodiments, the articles made from the resin composition disclosed herein may have at least one, preferably at least two, more or all, of the following properties:
a glass transition temperature as measured by reference to IPC-TM-650 2.4.24.5 of greater than or equal to 211° C.;
a Z-axis coefficient of thermal expansion as measured by reference to IPC-TM-650 2.4.24.5 of less than or equal to 47 ppm/° C.;
a dielectric constant as measured by reference to JIS C2565 at 10 GHz of less than or equal to 3.49;
a dissipation factor as measured by reference to JIS C2565 at 10 GHz of less than or equal to 0.0046;
a copper foil peeling strength as measured by reference to IPC-TM-650 2.4.8 of greater than or equal to 4.01 lb/in; and
a flame retardancy of V-0 rating as measured by reference to UL94.

Methods for measuring the aforesaid properties will be elaborated in detail below.

Raw materials below were used to prepare the resin compositions of various Examples and Comparative Examples of the present disclosure according to the amount listed in Table 1 to Table 5 and further fabricated to prepare test samples.

Materials and reagents used in Synthesis Examples, Examples and Comparative Examples disclosed herein are listed below:
Copolymer: CP1 to CP5, as described in Synthesis Example 1 to Synthesis Example 5.
Formula (1-1): phosphorus-containing flame retardant having a structure of Formula (1-1), available from UFC Corp.

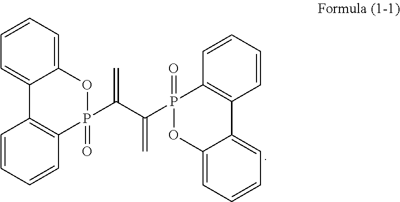 [SMILES: C=C(C(=C)P1(=O)Oc2ccccc2-c2ccccc21)P1(=O)Oc2ccccc2-c2ccccc21]

Formula (1-2): phosphorus-containing flame retardant having a structure of Formula (1-2), available from Coryes Polymer Science & Technology Co., Ltd.

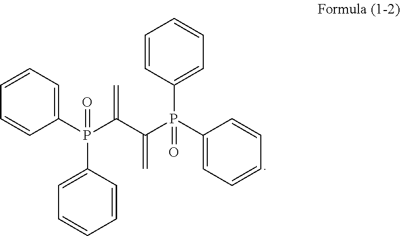 [SMILES: C=C(C(=C)P(=O)(c1ccccc1)c1ccccc1)P(=O)(c1ccccc1)c1ccccc1]

BMI-80: aromatic maleimide resin, available from K.I Chemical Industry Co., Ltd.
BMI-TMH: aliphatic maleimide resin, available from Sichuan EM Technology Co., Ltd.
BMI-70: aromatic maleimide resin, available from K.I Chemical Industry Co., Ltd.
MIR-5000: aromatic maleimide resin, available from Nippon Kayaku.
Bisaniline P: diamine compound, available from Mitsui Chemicals.
X-22-9409: diamine compound, available from Shin-Etsu Chemical Co., Ltd.
AF-217: polyimide resin, available from Chin Yee Chemical Co., Ltd.
FBCB: fluorene-containing benzocyclobutene, available from Shandong Xingshun New Material Co., Ltd.
HMPS: diallyl ether compound having a structure of Formula (4), available from Chang Chun Plastics Co., Ltd.

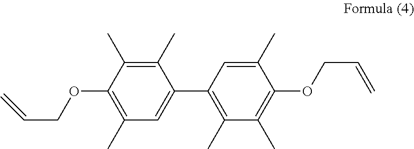 [SMILES: C=CCOc1c(C)cc(-c2cc(C)c(OCC=C)c(C)c2C)c(C)c1C]

OPE-2st 2200: vinylbenzyl group-containing biphenyl polyphenylene ether resin, available from Mitsubishi Gas Chemical Co., Inc.
SA9000: methacrylate group-containing polyphenylene ether resin, available from Sabic.
PX-200: resorcinol bis(2,6-dixylenyl phosphate), available from Daihachi Chemical Industry Co., Ltd.
PQ-60: p-xylylene-bis-diphenylphosphine oxide, available from Chin Yee Chemical Co., Ltd.
Di-DOPO: flame retardant having a structure of Formula (5), commercially available.

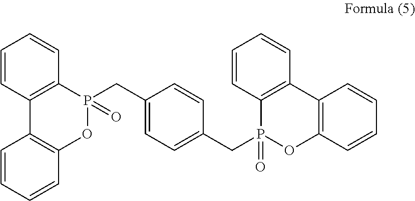 [SMILES: O=P1(Cc2ccc(CP3(=O)Oc4ccccc4-c4ccccc43)cc2)Oc2ccccc2-c2ccccc21]

SPV-100: allyl group-containing phosphazene compound, available from Otsuka Chemical Co., Ltd.
TPPK: tetraphenylphosphonium tetraphenylborate, commercially available.
ABN: sintered body formed by aluminum nitride and boron nitride, available from Ginet New Materials Technology Co., Ltd. In the Tables, the amount symbol “R” of inorganic filler represents that the amount of inorganic filler is a multiple of the total amount of all other components excluding inorganic filler, curing accelerator and solvent in the resin composition of each Example or each Comparative Example. In the Tables, “R*100%” represents the amount of inorganic filler is 1 fold of the total amount of the aforesaid all other components. For example, in Example E1, R*100% represents that the amount of inorganic filler is 135 parts by weight (the total amount of all other components excluding inorganic filler, curing accelerator and solvent in E1 is 135 parts by weight, so the amount of inorganic filler is 135 parts by weight times 100%, which is 135 parts by weight).
Anisole: commercially available. The amount of solvent is shown as “PA” in the Tables to indicate a “proper amount” to represent an amount of solvent used to achieve a 60% to 68% total solid content (S/C=60% to 68%) of the resin composition.
Propylene glycol methyl ether acetate: commercially available.
Ethylenediamine: commercially available.

### Synthesis Example 1

In a reaction tank, 3 moles of BMI-80, 1 mole of BMI-TMH, 1 mole of Bisaniline P, 100 parts by weight (approximately 0.76 mole) of propylene glycol methyl ether acetate and 0.5 part by weight (approximately 0.008 mole) of ethylenediamine were added, well mixed and dissolved by heating, followed by reacting at the constant temperature of 120° C. for 4 hours and then cooled to room temperature to obtain copolymer CP1, which is the copolymer of the present disclosure.

### Synthesis Example 2

In a reaction tank, 3 moles of BMI-80, 1 mole of BMI-TMH, 1 mole of X-22-9409, 100 parts by weight (approximately 0.76 mole) of propylene glycol methyl ether acetate and 0.5 part by weight (approximately 0.008 mole) of ethylenediamine were added, well mixed and dissolved by heating, followed by reacting at the constant temperature of 120° C. for 4 hours and then cooled to room temperature to obtain copolymer CP2, which is the copolymer of the present disclosure.

### Synthesis Example 3

In a reaction tank, 1 mole of BMI-TMH, 1 mole of Bisaniline P, 100 parts by weight (approximately 0.76 mole) of propylene glycol methyl ether acetate and 0.5 part by weight (approximately 0.008 mole) of ethylenediamine were added, well mixed and dissolved by heating, followed by reacting at the constant temperature of 120° C. for 4 hours and then cooled to room temperature to obtain copolymer CP3.

### Synthesis Example 4

In a reaction tank, 3 moles of BMI-80, 1 mole of Bisaniline P, 100 parts by weight (approximately 0.76 mole) of propylene glycol methyl ether acetate and 0.5 part by weight (approximately 0.008 mole) of ethylenediamine were added, well mixed and dissolved by heating, followed by reacting at the constant temperature of 120° C. for 4 hours and then cooled to room temperature to obtain copolymer CP4.

### Synthesis Example 5

In a reaction tank, 3 moles of BMI-80, 1 mole of BMI-TMH, 100 parts by weight (approximately 0.76 mole) of propylene glycol methyl ether acetate and 0.5 part by weight (approximately 0.008 mole) of ethylenediamine were added, well mixed and dissolved by heating, followed by reacting at the constant temperature of 120° C. for 4 hours and then cooled to room temperature to obtain copolymer CP5.

Compositions (in part by weight) and test results of resin compositions of Examples and Comparative Examples are listed below, wherein the part by weight refers to the amount, in part by weight, of each component with a solid content of 100%. For example, Example E1 contains 35 parts by weight of a phosphorus-containing flame retardant, indicating the amount of the phosphorus-containing flame retardant, with a solid content of 100%, is 35 parts by weight.

Compositions and test results of resin compositions of Examples and Comparative Examples are listed below (in part by weight).

TABLE 1
Resin compositions of Examples (in part by weight) and test results

| Component | Name | E1 | E2 | E3 | E4 | E5 |
|---|---|---|---|---|---|---|
| copolymer | CP1 | 100 | 100 | 100 | 100 | 100 |
| | CP2 | | | | | |
| | CP3 | | | | | |
| | CP4 | | | | | |
| | CP5 | | | | | |
| phosphorus-containing | Formula (1-1) | 35 | 20 | 60 | | |
| flame retardant | Formula (1-2) | | | | 35 | 60 |
| maleimide resin | BMI-80 | | | | | |
| | BMI-TMH | | | | | |
| | BMI-70 | | | | | |
| | MIR-5000 | | | | | |
| diamine compound | Bisaniline P | | | | | |
| additive | AF-217 | | | | | |
| | FBCB | | | | | |
| | HMPS | | | | | |
| | OPE-2st 2200 | | | | | |
| | SA9000 | | | | | |
| other flame retardant | PX-200 | | | | | |
| | PQ-60 | | | | | |
| | Di-DOPO | | | | | |
| | SPV-100 | | | | | |
| curing accelerator | TPPK | 0.5 | 0.5 | 0.5 | 0.5 | 0.5 |
| inorganic filler | ABN | R*100% | R*100% | R*100% | R*100% | R*100% |
| solvent | anisole | PA | PA | PA | PA | PA |
| Property | Unit | E1 | E2 | E3 | E4 | E5 |
| TMA-Tg | ° C. | 225 | 219 | 239 | 218 | 229 |
| Z-CTE | ppm/° C. | 45 | 47 | 35 | 47 | 41 |
| Dk (10 GHz) | none | 3.45 | 3.49 | 3.37 | 3.36 | 3.35 |
| Df (10 GHz) | none | 0.0045 | 0.0042 | 0.0033 | 0.0042 | 0.0046 |
| P/S | lb/in | 4.65 | 4.83 | 4.38 | 4.33 | 4.01 |
| flame retardancy | none | V-0 | V-0 | V-0 | V-0 | V-0 |

TABLE 2
Resin compositions of Examples (in part by weight) and test results

| Component | Name | E6 | E7 | E8 | E9 | E10 |
|---|---|---|---|---|---|---|
| copolymer | CP1 | | | 100 | 100 | |
| | CP2 | 100 | 100 | | | 100 |
| | CP3 | | | | | |
| | CP4 | | | | | |
| | CP5 | | | | | |
| phosphorus-containing | Formula (1-1) | 35 | | 35 | | 35 |
| flame retardant | Formula (1-2) | | 35 | | 35 | |
| maleimide resin | BMI-80 | | | | | |
| | BMI-TMH | | | | | |
| | BMI-70 | | | | | |
| | MIR-5000 | | | | | |
| diamine compound | Bisaniline P | | | | | |
| additive | AF-217 | | | | | |
| | FBCB | | | | | |
| | HMPS | | | | | |
| | OPE-2st 2200 | | | 5 | 15 | 20 |
| | SA9000 | | | 20 | 10 | 5 |
| other flame retardant | PX-200 | | | | | |
| | PQ-60 | | | | | |
| | Di-DOPO | | | | | |
| | SPV-100 | | | | | |
| curing accelerator | TPPK | 0.5 | 0.5 | 0.5 | 0.5 | 0.5 |
| inorganic filler | ABN | R*100% | R*100% | R*100% | R*100% | R*100% |
| solvent | anisole | PA | PA | PA | PA | PA |
| Property | Unit | E6 | E7 | E8 | E9 | E10 |
| TMA-Tg | ° C. | 231 | 234 | 232 | 235 | 230 |
| Z-CTE | ppm/° C. | 31 | 33 | 37 | 35 | 39 |
| Dk (10 GHz) | none | 3.11 | 3.18 | 3.29 | 3.25 | 3.21 |
| Df (10 GHz) | none | 0.0043 | 0.0041 | 0.0041 | 0.0039 | 0.0039 |
| P/S | lb/in | 4.13 | 4.01 | 4.41 | 4.43 | 4.46 |
| flame retardancy | none | V-0 | V-0 | V-0 | V-0 | V-0 |

TABLE 3
Resin compositions of Examples (in part by weight) and test results

| Component | Name | E11 | E12 | E13 | E14 |
|---|---|---|---|---|---|
| copolymer | CP1 | 100 | 100 | 100 | 100 |
| | CP2 | | | | |
| | CP3 | | | | |
| | CP4 | | | | |
| | CP5 | | | | |
| phosphorus-containing | Formula (1-1) | 35 | 35 | 35 | 15 |
| flame retardant | Formula (1-2) | | | | 15 |
| maleimide resin | BMI-80 | | | 30 | |
| | BMI-TMH | 10 | | | |
| | BMI-70 | | | | |
| | MIR-5000 | 5 | | | |
| diamine compound | Bisaniline P | | | | |
| additive | AF-217 | | 5 | 20 | 10 |
| | FBCB | | | 15 | 20 |
| | HMPS | | | 10 | 5 |
| | OPE-2st 2200 | | | | |
| | SA9000 | | | | |
| other flame retardant | PX-200 | | | | |
| | PQ-60 | | | | |
| | Di-DOPO | | | | |
| | SPV-100 | | | | |
| curing accelerator | TPPK | 0.5 | 0.5 | 0.8 | 0.3 |
| inorganic filler | ABN | R*100% | R*100% | R*120% | R*80% |
| solvent | anisole | PA | PA | PA | PA |

| Property | Unit | E11 | E12 | E13 | E14 |
|---|---|---|---|---|---|
| TMA-Tg | ° C. | 211 | 218 | 228 | 235 |
| Z-CTE | ppm/° C. | 43 | 47 | 42 | 39 |
| Dk (10 GHz) | none | 3.37 | 3.42 | 3.31 | 3.26 |
| Df (10 GHz) | none | 0.0044 | 0.0043 | 0.0036 | 0.0033 |
| P/S | lb/in | 4.49 | 5.15 | 5.41 | 5.27 |
| flame retardancy | none | V-0 | V-0 | V-0 | V-0 |

TABLE 4
Resin compositions of Comparative Examples (in part by weight) and test
results

| Component | Name | C1 | C2 | C3 | C4 | C5 |
|---|---|---|---|---|---|---|
| copolymer | CP1 | | | | 100 | |
| | CP2 | | | | | |
| | CP3 | 100 | | | | |
| | CP4 | | 100 | | | |
| | CP5 | | | 100 | | |
| phosphorus-containing | Formula (1-1) | 35 | 35 | 35 | | 35 |
| flame retardant | Formula (1-2) | | | | | |
| maleimide resin | BMI-80 | | | | | |
| | BMI-TMH | | | | | |
| | BMI-70 | | | | | 100 |
| | MIR-5000 | | | | | |
| diamine compound | Bisaniline P | | | | | |
| additive | AF-217 | | | | | |
| | FBCB | | | | | |
| | HMPS | | | | | |
| | OPE-2st 2200 | | | | | |
| | SA9000 | | | | | |
| other flame retardant | PX-200 | | | | | |
| | PQ-60 | | | | | |
| | Di-DOPO | | | | | |
| | SPV-100 | | | | | |
| curing accelerator | TPPK | 0.5 | 0.5 | 0.5 | 0.5 | 0.5 |
| inorganic filler | ABN | R*100% | R*100% | R*100% | R*100% | R*100% |
| solvent | anisole | PA | PA | PA | PA | PA |
| Property | Unit | C1 | C2 | C3 | C4 | C5 |
| TMA-Tg | ° C. | 170 | 243 | 232 | 206 | 150 |
| Z-CTE | ppm/° C. | 55 | 38 | 33 | 51 | 110 |
| Dk (10 GHz) | none | 3.39 | 3.74 | 3.75 | 3.51 | 3.80 |
| Df (10 GHz) | none | 0.0051 | 0.0068 | 0.0075 | 0.0053 | 0.0083 |
| P/S | lb/in | 3.57 | 3.86 | 3.54 | 5.01 | 3.25 |
| flame retardancy | none | V-0 | V-0 | V-0 | burnout | V-C |

TABLE 5
Resin compositions of Comparative Examples (in part by weight) and test
results

| Component | Name | C6 | C7 | C8 | C9 | C10 |
|---|---|---|---|---|---|---|
| copolymer | CP1 | | 100 | 100 | 100 | 100 |
| | CP2 | | | | | |
| | CP3 | | | | | |
| | CP4 | | | | | |
| | CP5 | | | | | |
| phosphorus-containing | Formula (1-1) | 35 | | | | |
| flame retardant | Formula (1-2) | | | | | |
| maleimide resin | BMI-80 | 73 | | | | |
| | BMI-TMH | 13 | | | | |
| | BMI-70 | | | | | |
| | MIR-5000 | | | | | |
| diamine compound | Bisaniline P | 14 | | | | |
| additive | AF-217 | | | | | |
| | FBCB | | | | | |
| | HMPS | | | | | |
| | OPE-2st 2200 | | | | | |
| | SA9000 | | | | | |
| other flame retardant | PX-200 | | 35 | | | |
| | PQ-60 | | | 35 | | |
| | Di-DOPO | | | | 35 | |
| | SPV-100 | | | | | 35 |
| curing accelerator | TPPK | 0.5 | 0.5 | 0.5 | 0.5 | 0.5 |
| inorganic filler | ABN | R*100% | R*100% | R*100% | R*100% | R*100% |
| solvent | anisole | PA | PA | PA | PA | PA |
| Property | Unit | C6 | C7 | C8 | C9 | C10 |
| TMA-Tg | ° C. | 184 | 153 | 176 | 180 | 164 |
| Z-CTE | ppm/° C. | 62 | 82 | 55 | 52 | 88 |
| Dk (10 GHz) | none | 3.66 | 3.47 | 3.63 | 3.69 | 3.89 |
| Df (10 GHz) | none | 0.0075 | 0.0046 | 0.0047 | 0.0049 | 0.0065 |
| P/S | lb/in | 3.77 | 4.43 | 3.01 | 3.99 | 4.17 |
| flame retardancy | none | V-0 | V-1 | V-0 | V-0 | V-1 |

Samples (specimens) for the properties measured above were prepared as described below and tested and analyzed under specified conditions below.

### 1. Prepreg 1 (PP 1)

Resin composition (in part by weight) from each Example or each Comparative Example was separately added to a stirred tank and well-mixed to form a varnish. The varnish was loaded to an impregnation tank, and a fiberglass fabric (e.g., 2116 L-glass fiber fabric, available from Asahi) was impregnated into the impregnation tank to adhere the resin composition onto the fiberglass fabric, followed by heating at 100° C. to 140° C. to the semi-cured state (B-stage) to obtain the prepreg 1, having a resin content of about 70%.

### 2. Prepreg 2 (PP 2)

Resin composition (in part by weight) from each Example or each Comparative Example was separately added to a stirred tank and well-mixed to form a varnish. The varnish was loaded to an impregnation tank, and a fiberglass fabric (e.g., 1078 L-glass fiber fabric, available from Asahi) was impregnated into the impregnation tank to adhere the resin composition onto the fiberglass fabric, followed by heating at 100° C. to 140° C. to the semi-cured state (B-stage) to obtain the prepreg 2, having a resin content of about 70%.

### 3. Copper-Containing Laminate 1 (Obtained by Laminating Two Prepregs 1)

Two 0.5 oz reverse treatment foils (RTF copper foils) and two prepregs 1 obtained from 2116 L-glass fiber fabrics impregnated with each Example or Comparative Example were prepared. A copper foil, two prepregs 1 and a copper foil were superimposed in such order and then subjected to a vacuum condition for lamination at 250 psi to 600 psi and 200° C. to 220° C. for 90 minutes to 120 minutes to form each copper-containing laminate 1. The two prepregs 1 were cured to form an insulation layer between the two copper foils, and the insulation layer has a resin content of about 70%.

### 4. Copper-Containing Laminate 2 (Obtained by Laminating Eight Prepregs 1)

Two 0.5 oz reverse treatment foils (RTF copper foils) and eight prepregs 1 obtained from 2116 L-glass fiber fabrics impregnated with each Example or Comparative Example were prepared. A copper foil, eight prepregs 1 and a copper foil were superimposed in such order and then subjected to a vacuum condition for lamination at 250 psi to 600 psi and 200° C. to 220° C. for 90 minutes to 120 minutes to form each copper-containing laminate 2. The eight prepregs 1 were cured to form an insulation layer between the two copper foils, and the insulation layer has a resin content of about 70%.

### 5. Copper-Containing Laminate 3 (Obtained by Laminating Two Prepregs 2)

Two 0.5 oz reverse treatment foils (RTF copper foils) and two prepregs 2 obtained from 1078 L-glass fiber fabrics impregnated with each Example or Comparative Example were prepared. A copper foil, two prepregs 2 and a copper foil were superimposed in such order and then subjected to a vacuum condition for lamination at 250 psi to 600 psi and 200° C. to 220° C. for 90 minutes to 120 minutes to form each copper-containing laminate 3. The two prepregs 2 were cured to form an insulation layer between the two copper foils, and the insulation layer has a resin content of about 70%.

### 6. Copper-Containing Laminate 4 (Obtained by Laminating Eight Prepregs 2)

Two 0.5 oz reverse treatment foils (RTF copper foils) and eight prepregs 2 obtained from 1078 L-glass fiber fabrics impregnated with each Example or Comparative Example were prepared. A copper foil, eight prepregs 2 and a copper foil were superimposed in such order and then subjected to a vacuum condition for lamination at 250 psi to 600 psi and 200° C. to 220° C. for 90 minutes to 120 minutes to form each copper-containing laminate 4. The eight prepregs 2 were cured to form an insulation layer between the two copper foils, and the insulation layer has a resin content of about 70%.

### 7. Copper-Free Laminate 1 (Obtained by Laminating Two Prepregs 1)

Each copper-containing laminate 1 was etched to remove copper foils on both sides so as to obtain the copper-free laminate 1.

### 8. Copper-Free Laminate 2 (Obtained by Laminating Eight Prepregs 1)

Each copper-containing laminate 2 was etched to remove copper foils on both sides so as to obtain the copper-free laminate 2.

### 9. Copper-Free Laminate 3 (Obtained by Laminating Two Prepregs 2)

Each copper-containing laminate 3 was etched to remove copper foils on both sides so as to obtain the copper-free laminate 3.

### 10. Copper-Free Laminate 4 (Obtained by Laminating Eight Prepregs 2)

Each copper-containing laminate 4 was etched to remove copper foils on both sides so as to obtain the copper-free laminate 4.

For each sample, test items and test methods are described below.

### Glass Transition Temperature (TMA-Tg)

The copper-free laminate 2 (obtained by laminating eight prepregs 1) sample was subjected to glass transition temperature measurement by using the thermal mechanical analysis (TMA) method. Each sample was heated from 35° C. to 350° C. at a heating rate of 10° C./minute and then subjected to the measurement of glass transition temperature (° C.) by reference to the method described in IPC-TM-650 2.4.24.5.

In the technical field to which the present disclosure pertains, higher glass transition temperature is better. A difference in glass transition temperature of greater than or equal to 5° C. represents a substantial difference (i.e., significant technical difficulty) in glass transition temperature in different laminates. For example, articles made from the resin composition disclosed herein have a glass transition temperature of greater than or equal to 211° C. as measured by reference to IPC-TM-650 2.4.24.5, such as between 211° C. and 239° C.

### Z-Axis Coefficient of Thermal Expansion (Z-CTE)

The copper-free laminate 4 (obtained by laminating eight prepregs 2) sample was tested by thermal mechanical analysis (TMA) during the measurement of Z-axis coefficient of thermal expansion. The copper-free laminate 4 was cut into a sample with a length of 10 mm and a width of 10 mm. Each sample was heated from 35° C. to 300° C. at a heating rate of 10° C./minute and then subjected to the measurement of Z-axis coefficient of thermal expansion (ppm/° C.) in a temperature range (al) of 50° C. to 110° C. by reference to IPC-TM-650 2.4.24.5.

In the technical field to which the present disclosure pertains, lower Z-axis coefficient of thermal expansion is better. A difference in Z-axis coefficient of thermal expansion of greater than or equal to 5 ppm/° C. represents a substantial difference (i.e., significant technical difficulty) in Z-axis coefficient of thermal expansion in different laminates. For example, articles made from the resin composition disclosed herein have a Z-axis coefficient of thermal expansion as measured by reference to IPC-TM-650 2.4.24.5 of less than or equal to 47 ppm/° C., such as between 31 ppm/° C. and 47 ppm/° C.

### Dielectric Constant (Dk)

The aforesaid copper-free laminate 3 (obtained by laminating two prepregs 2) sample was subjected to dielectric constant measurement. Each sample was tested by using a microwave dielectrometer (available from AET Corp.) by reference to JIS C2565 at room temperature (about 25° C.) and under a 10 GHz frequency to obtain the dielectric constant.

In the technical field to which the present disclosure pertains, lower dielectric constant represents better dielectric properties of the sample, and a difference in dielectric constant of greater than or equal to 0.20 represents a substantial difference (i.e., significant technical difficulty) in dielectric constant of different laminates. For example, articles made from the resin composition disclosed herein have a dielectric constant as measured by reference to JIS C2565 at 10 GHz of less than or equal to 3.49, such as between 3.11 and 3.49.

### Dissipation Factor (Df)

The aforesaid copper-free laminate 1 (obtained by laminating two prepregs 1) was subjected to dissipation factor measurement. Each sample was tested by using a microwave dielectrometer (available from AET Corp.) by reference to JIS C2565 at room temperature (about 25° C.) and under a 10 GHz frequency to obtain the dissipation factor.

In the technical field to which the present disclosure pertains, lower dissipation factor represents better dielectric properties of the sample, and a difference in dissipation factor of greater than or equal to 0.0005 represents a substantial difference (i.e., significant technical difficulty) in dissipation factor of different laminates. For example, articles made from the resin composition disclosed herein have a dissipation factor as measured by reference to JIS C2565 at 10 GHz of less than or equal to 0.0046, such as between 0.0033 and 0.0046.

### Copper Foil Peeling Strength (Hoz Peeling Strength, Hoz P/S)

In the measurement of copper foil peeling strength, the aforesaid copper-containing laminate 2 (obtained by laminating eight prepregs 1) was cut into a rectangular sample with a width of 24 mm and a length of greater than 60 mm, which was etched to remove surface copper foil to leave a rectangular copper foil with a width of 3.18 mm and a length of greater than 60 mm, and tested by using a tensile strength tester by reference to IPC-TM-650 2.4.8 at room temperature (about 25° C.) to measure the force (lb/in) required to separate the copper foil from the insulation layer of the laminate.

In the technical field to which the present disclosure pertains, higher copper foil peeling strength is better. A difference in copper foil peeling strength of greater than or equal to 0.1 lb/in represents a substantial difference (i.e., significant technical difficulty) in copper foil peeling strength in different laminates. For example, articles made from the resin composition disclosed herein have a copper foil peeling strength as measured by reference to IPC-TM-650 2.4.8 of greater than or equal to 4.01 lb/in, such as between 4.01 lb/in and 5.41 lb/in.

### Flame Retardancy

A 125 mm×13 mm copper-free laminate 2 (obtained by laminating eight prepregs 1) sample was used in the flame retardancy test. The flame retardancy test was performed in accordance with the UL94 rating, and the results were represented by V-0, V-1, or V-2, wherein V-0 indicates a superior flame retardancy to V-1, V-1 indicates a superior flame retardancy to V-2, and burnout of sample is the worst. For example, articles made from the resin composition disclosed herein have a flame retardancy of V-0 as measured by reference to the UL94 rating.

The following observations can be made from Table 1 to Table 5.

If the resin composition comprises a copolymer and a phosphorus-containing flame retardant, the copolymer being prepared from a mixture subjected to a copolymerization reaction, wherein the mixture comprises a maleimide resin and a diamine compound, the maleimide resin comprises an aromatic maleimide resin and an aliphatic maleimide resin, and the phosphorus-containing flame retardant has a structure represented by Formula (1), such as Examples E1 to E14, it can achieve improvements in properties including a glass transition temperature of greater than or equal to 211° C., a Z-axis coefficient of thermal expansion of less than or equal to 47 ppm/° C., a dielectric constant of less than or equal to 3.49, a dissipation factor of less than or equal to 0.0046, a copper foil peeling strength of greater than or equal to 4.01 lb/in and a flame retardancy of V-0 rating. In contrast, Comparative Examples C1 to C10 fail to achieve desirable results in at least one of the aforesaid properties.

In contrast to Example E1, if the aromatic maleimide resin is not used in the process of preparing the copolymer, such as Comparative Example C1, it will fail to achieve desirable results in glass transition temperature, Z-axis coefficient of thermal expansion, dissipation factor and copper foil peeling strength.

In contrast to Example E1, if the aliphatic maleimide resin is not used in the process of preparing the copolymer, such as Comparative Example C2, it will fail to achieve desirable results in dielectric constant, dissipation factor and copper foil peeling strength.

In contrast to Example E1, if the diamine compound is not used in the process of preparing the copolymer, such as Comparative Example C3, it will fail to achieve desirable results in dielectric constant, dissipation factor and copper foil peeling strength.

In contrast to Examples E1 and E4, if the resin composition does not contain the phosphorus-containing flame retardant having a structure of Formula (1), such as Comparative Example C4, it will fail to achieve desirable results in glass transition temperature, Z-axis coefficient of thermal expansion, dielectric constant, dissipation factor and flame retardancy.

In contrast to Example E1, if the resin composition does not contain the copolymer of the present disclosure but contains an aromatic maleimide resin, such as Comparative Example C5, it will fail to achieve desirable results in glass transition temperature, Z-axis coefficient of thermal expansion, dielectric constant, dissipation factor and copper foil peeling strength.

In contrast to Example E1, if the resin composition does not contain the copolymer of the present disclosure but contains a monomer of the copolymer added separately, such as Comparative Example C6, it will fail to achieve desirable results in glass transition temperature, Z-axis coefficient of thermal expansion, dielectric constant, dissipation factor and copper foil peeling strength.

In contrast to Examples E1 and E4, if the resin composition does not contain the phosphorus-containing flame retardant having a structure of Formula (1) but contains PX-200, such as Comparative Example C7, it will fail to achieve desirable results in glass transition temperature, Z-axis coefficient of thermal expansion and flame retardancy.

In contrast to Examples E1 and E4, if the resin composition does not contain the phosphorus-containing flame retardant having a structure of Formula (1) but contains PQ-60, such as Comparative Example C8, it will fail to achieve desirable results in glass transition temperature, Z-axis coefficient of thermal expansion, dielectric constant, dissipation factor and copper foil peeling strength.

In contrast to Examples E1 and E4, if the resin composition does not contain the phosphorus-containing flame retardant having a structure of Formula (1) but contains Di-DOPO, such as Comparative Example C9, it will fail to achieve desirable results in glass transition temperature, Z-axis coefficient of thermal expansion, dielectric constant, dissipation factor and copper foil peeling strength.

In contrast to Examples E1 and E4, if the resin composition does not contain the phosphorus-containing flame retardant having a structure of Formula (1) but contains SPV-100, such as Comparative Example C10, it will fail to achieve desirable results in glass transition temperature, Z-axis coefficient of thermal expansion, dielectric constant, dissipation factor and flame retardancy.

Overall, the resin composition of the present disclosure and an article made therefrom, such as Examples E1 to E14, can all achieve desirable results at the same time including a glass transition temperature of greater than or equal to 211° C., a Z-axis coefficient of thermal expansion of less than or equal to 47 ppm/° C., a dielectric constant of less than or equal to 3.49, a dissipation factor of less than or equal to 0.0046, a copper foil peeling strength of greater than or equal to 4.01 lb/in and a flame retardancy of V-0 rating.

The above detailed description and examples are merely illustrative in nature and are not intended to limit the embodiments of the subject matter or the applications and uses of such embodiments. As used herein, the term “exemplary” or similar expression means “serving as an example, instance, or illustration.” Any implementation described herein as exemplary is not necessarily to be construed as preferred or advantageous over other implementations, unless otherwise specified.

Moreover, while at least one exemplary example or comparative example has been presented in the foregoing detailed description, it should be appreciated that a vast number of variations exist. It should also be appreciated that the exemplary one or more embodiments described herein are not intended to limit the scope, applicability, or configuration of the claimed subject matter in any way. Rather, the foregoing detailed description can provide those skilled in the art with a convenient guide for implementing the described one or more embodiments and equivalents thereof. Also, the scope defined by the claims includes known equivalents and foreseeable equivalents at the time of filing this patent application.

What is claimed is:

1. A resin composition, comprising:
a copolymer prepared from a mixture subjected to a copolymerization reaction, wherein the mixture comprises a maleimide resin and a diamine compound, and the maleimide resin comprises an aromatic maleimide resin and an aliphatic maleimide resin; and
a phosphorus-containing flame retardant having a structure represented by Formula (1): 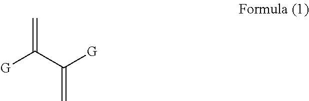
wherein G each independently represent a group of Formula (2) or a group of Formula (3): 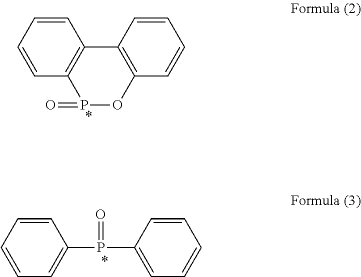
wherein symbol * represents a bonding position to carbon atom.

2. The resin composition of claim 1, comprising 100 parts by weight of the copolymer and 20 parts by weight to 60 parts by weight of the phosphorus-containing flame retardant.

3. The resin composition of claim 1, wherein the mixture comprises the aromatic maleimide resin, the aliphatic maleimide resin and the diamine compound in a molar ratio of between 2:0.5:0.1 and 5:2:1.

4. The resin composition of claim 1, wherein the phosphorus-containing flame retardant has a structure of Formula (1-1):

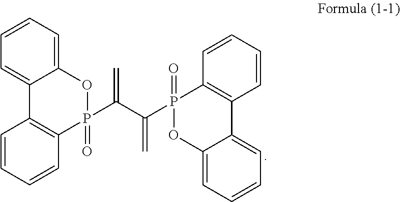 [SMILES: C=C(C(=C)P1(=O)Oc2ccccc2-c2ccccc21)P1(=O)Oc2ccccc2-c2ccccc21]

5. The resin composition of claim 1, wherein the phosphorus-containing flame retardant has a structure of Formula (1-2):

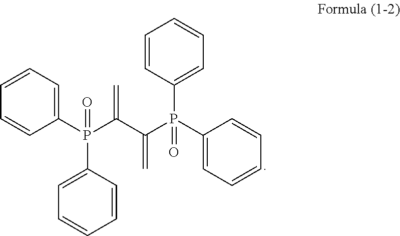 [SMILES: C=C(C(=C)P(=O)(c1ccccc1)c1ccccc1)P(=O)(c1ccccc1)c1ccccc1]

6. The resin composition of claim 1, wherein the aromatic maleimide resin comprises 4,4′-diphenylmethane bismaleimide, polyphenylmethane maleimide, bisphenol A diphenyl ether bismaleimide, 3,3′-dimethyl-5,5′-diethyl-4,4′-diphenylmethane bismaleimide, 3,3′-dimethyl-5,5′-dipropyl-4,4′-diphenylmethane bismaleimide, m-phenylene bismaleimide, 4-methyl-1,3-phenylene bismaleimide, N-2,3-dimethylphenyl maleimide, N-2,6-dimethylphenyl maleimide, N-phenylmaleimide, vinyl benzyl maleimide, maleimide containing biphenyl structure, maleimide containing indane structure, maleimide containing isopropylidene and m-phenylene structure or a combination thereof.

7. The resin composition of claim 1, wherein the aliphatic maleimide resin comprises 1,6-bismaleimide-(2,2,4-trimethyl)hexane, maleimide containing a C₁₀ to C₅₀ aliphatic long chain structure or a combination thereof.

8. The resin composition of claim 1, wherein the diamine compound comprises 4,4′-(1,4-phenylenediisopropylidene)bisaniline, a diamine compound containing a siloxane structure or a combination thereof.

9. The resin composition of claim 1, further comprising an additive which comprises a vinyl group-containing polyphenylene ether resin, a polyimide resin, a benzocyclobutene, a diallyl ether compound or a combination thereof.

10. The resin composition of claim 1, further comprising inorganic filler, curing accelerator, polymerization inhibitor, solvent, silane coupling agent, coloring agent, toughening agent or a combination thereof.

11. An article made from the resin composition of claim 1, comprising a prepreg, a resin film, a laminate or a printed circuit board.

12. The article of claim 11, which has one, more or all of the following properties:
a glass transition temperature as measured by reference to IPC-TM-650 2.4.24.5 of greater than or equal to 211° C.;
a Z-axis coefficient of thermal expansion as measured by reference to IPC-TM-650 2.4.24.5 of less than or equal to 47 ppm/° C.;
a dielectric constant as measured by reference to JIS C2565 at 10 GHz of less than or equal to 3.49;
a dissipation factor as measured by reference to JIS C2565 at 10 GHz of less than or equal to 0.0046;
a copper foil peeling strength as measured by reference to IPC-TM-650 2.4.8 of greater than or equal to 4.01 lb/in; and
a flame retardancy of V-0 rating as measured by reference to UL94.
